(19) United States
(12) Patent Application Publication
(10) Pub. No.: US 2026/0120573 A1
(43) Pub. Date: Apr. 30, 2026

(54) ESTIMATING LANE-LEVEL RISK

(71) Applicant: Toyota Motor Engineering & Manufacturing North America, Inc., Plano, TX (US)

(72) Inventors: Yashar Zeiynali Farid, San Jose, CA (US); Lu Xu, Canton, MI (US); Chunghan Lee, Mountain View, CA (US); Maryam Khabazi, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/928,391

(22) Filed: Oct. 28, 2024

(51) Int. Cl. G08G 1/16; G08G 1/01; G08G 1/0967

(52) U.S. Cl. CPC G08G 1/167; G08G 1/0112; G08G 1/0129; G08G 1/0133; G08G 1/096725; G08G 1/166

(57) ABSTRACT

Systems, methods, and other embodiments described herein relate to improving the safety of vehicles by determining lane-level risks of road segments. In one embodiment, a method includes acquiring data about a segment of a roadway. The data indicates at least information about traffic on the segment. The method includes determining a lane-level risk associated with a safety event occurring on the segment using a likelihood model and an impact model. The method includes providing the lane-level risk to cause an approaching vehicle to selectively adapt operation.

### TECHNICAL FIELD

The subject matter described herein relates, in general, to improving vehicle safety by estimating risks and, more particularly, to inferring lane-level risks according to crowd-sourced information.

### BACKGROUND

Vehicles may be equipped with sensors that facilitate perceiving other vehicles, obstacles, pedestrians, and additional aspects of a surrounding environment. For example, a vehicle may be equipped with a light detection and ranging (LIDAR) sensor that uses light to scan the surrounding environment, while logic associated with the LIDAR analyzes acquired data to detect a presence of objects and other features of the surrounding environment. In further examples, additional/alternative sensors such as cameras may be implemented to acquire information about the surrounding environment from which a system derives awareness about aspects of the surrounding environment. This sensor data can be useful in various circumstances for improving perceptions of the surrounding environment so that systems can perceive the noted aspects and accurately perform associated functions.

In general, the further awareness is developed by the vehicle about a surrounding environment, the better a driver can be supplemented with information to assist in driving and/or the better an automated system (e.g., adaptive cruise control) can control the vehicle to avoid hazards. However, the sensor data acquired by the various sensors is generally limited to an area around the vehicle and to a time associated with acquisition. As such, the vehicle may not have awareness about areas ahead on a route and/or tendencies associated with different hazards along a route. As a result, the vehicle must generally navigate the hazards as they are perceived, which can increase the risk to the vehicle.

### SUMMARY

In various embodiments, example systems and methods relate to a manner of improving vehicle safety by determining lane-level risks for segments of a roadway. As previously noted, a vehicle may be limited to awareness of threats in an immediate area around the vehicle at a time when the vehicle is traversing a particular road segment. Consequently, the vehicle may be unaware of different hazards that are present along a route and historical trends of hazards in different areas. As such, the vehicle may encounter increased threats from these latent risks.

Therefore, in one or more embodiments, an inventive system is disclosed that acquires information about road segments in both real-time and according to historical activity to assess lane-level risks that can be communicated to approaching vehicles to improve risk response along the segments. For example, in at least one approach, the system crowd-sources data from connected vehicles that traverse a roadway. That is, as various vehicles that include sensors and are able to communicate wirelessly traverse a road segment, the vehicles communicate with the system in order to provide information about a current state of the segment. The system can then use the information in multiple ways. First, the system is able to accumulate the information over time and can use the accumulated information to train an impact model and a likelihood model about a safety event for a road segment. The separate models characterize different aspects of a safety event. The likelihood model, in one arrangement, characterizes a likelihood of the occurrence of the safety event according to a current state/conditions on the segment (e.g., traffic density, traffic flow rates, etc.). The impact model, in one arrangement, characterizes a severity of the safety event (e.g., an extent of damage or threat to the health of passengers of a vehicle). Accordingly, from this accumulated information, the system can train the separate models to characterize the respective aspects for a given segment.

Second, the system can use the information to provide estimates about the lane-level risk according to current conditions. That is, as vehicles traverse the segment, the system can acquire information from the vehicles and use the models to characterize the respective current attributes, i.e., the current likelihood of the occurrence of the safety event and the current impact associate with an occurrence. Using the current impact and the current likelihood that the system calculates using the likelihood model and the impact model, the system can then determine the lane-level risk by combining the impact and the likelihood into a single discrete term. In various arrangements, the system may provide (e.g., communicate to an approaching vehicle) a map with discrete cells for the segment that include the lane-level risk values for the separate cells. The map causes the approaching vehicle to assess the lane-level risk throughout the segment from which the vehicle can then take actions to mitigate the risk. For example, the vehicle can adapt operation of one or more advanced driving assistance systems (ADAS) by altering operating parameters (e.g., speed, lane change, etc.), providing warnings to the driver, and so on. In this way, the system is able to improve the operation of the vehicle by better accounting for latent risks.

In one embodiment, a risk system is disclosed. The parking system includes one or more processors and a memory communicably coupled to the one or more processors. The memory stores a control module including instructions that, when executed by the one or more processors, cause the one or more processors to acquire data about a segment of a roadway, the data indicating at least information about traffic on the segment. The control module includes instructions to determine a lane-level risk associated with a safety event occurring on the segment using a likelihood model and an impact model. The control module includes instructions to provide the lane-level risk to cause an approaching vehicle to selectively adapt operation.

In one embodiment, a non-transitory computer-readable medium including instructions that, when executed by one or more processors, cause the one or more processors to perform one or more functions is disclosed. The instructions include instructions to acquire data about a segment of a roadway, the data indicating at least information about traffic on the segment. The instructions include instructions to determine a lane-level risk associated with a safety event occurring on the segment using a likelihood model and an impact model. The instructions include instructions to provide the lane-level risk to cause an approaching vehicle to selectively adapt operation.

In one embodiment, a method is disclosed. In one embodiment, the method includes acquiring data about a segment of a roadway, the data indicating at least information about traffic on the segment. The method includes determining a lane-level risk associated with a safety event occurring on the segment using a likelihood model and an impact model. The method includes providing the lane-level risk to cause an approaching vehicle to selectively adapt operation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a risk system associated with improving vehicle safety by determining lane-level risks for segments of a roadway.

FIG. 3 illustrates a diagram of a risk system within a cloud-computing environment.

FIG. 4 is a system diagram illustrating one embodiment of a cloud-side instance and a vehicle-side instance of the risk system of FIG. 2.

FIG. 5 is a flowchart illustrating one embodiment of cloud-based determination of lane-level risk.

FIG. 6 is a flowchart illustrating one embodiment of vehicle-based determinations using the lane-level risk.

FIGS. 7A-C illustrate example scenarios in which the risk system determines the lane-level risk and communicate the lane-level risk to an approaching vehicle.

### DETAILED DESCRIPTION

Systems, methods, and other embodiments associated with a manner of improving vehicle safety by determining lane-level risks for segments of a roadway. As previously noted, a vehicle may be limited to awareness of threats in an immediate area around the vehicle at a time when the vehicle is traversing a particular road segment. Consequently, the vehicle may be unaware of different hazards that are present along a route and historical trends of hazards in different areas. As such, the vehicle may encounter increased threats from these latent risks.

Therefore, in one or more embodiments, an inventive system is disclosed that acquires information about road segments in both real-time and according to historical activity to assess lane-level risks that can be communicated to approaching vehicles to improve risk response along the segments. For example, in at least one approach, the system crowd-sources data from connected vehicles that traverse a roadway. That is, as various vehicles, which include sensors and are able to communicate wirelessly, traverse a road segment, the vehicles communicate with the system in order to provide information about a current state of the segment. The system can then use the information in multiple ways. First, the system is able to accumulate the information over time and can use the accumulated information to train an impact model and a likelihood model about a safety event for a road segment. The separate models characterize different aspects of a safety event. The likelihood model, in one arrangement, characterizes a likelihood of the occurrence of the safety event according to a current state on the segment (e.g., traffic density, traffic flow rates, etc.). The impact model, in one arrangement, characterizes a severity of the safety event (e.g., an extent of damage or threat to the health of passengers of a vehicle). Accordingly, from this accumulated information, the system can train the separate models to characterize the respective aspects for a given segment in relation to the safety event.

The safety event itself is an event that effects the safety of the vehicle and passengers of the vehicle. Various examples of safety events include actions of other vehicles resulting in traffic incidents, such as cut-ins, and cut-outs. Further examples, include roadway hazards, such as obstacles, emergency vehicles, pedestrians, and so on. In yet further embodiments, the safety events resulting in accidents may include static aspects of a roadway, such as narrow shoulders, obscured views, and so on. Thus, the system can characterize the risks at different segments by collecting data about occurrences and the conditions that cause the occurrences to model the separate aspects of the risks in a granular fashion associated with each lane and with cells along the lanes.

Second, the system can use the information to provide estimates about the lane-level risk according to current conditions. That is, as vehicles traverse the segment, the system can acquire information from the vehicles and use the models to characterize the respective current attributes, i.e., the current likelihood of the occurrence of the safety event and the current impact associated with an occurrence. It should be appreciated that the acquired information may vary but generally includes at least information about traffic along the segment, which is provided on a per-lane basis. Of course, in further arrangements, the data may also include traffic flow rates, weather, and other information about the road segment.

In any case, using the current impact and the current likelihood that the system calculates using the likelihood model and the impact model, the system can then determine the lane-level risk by combining the impact and the likelihood into a single discrete term. The system may iterate this process over many different cells within a segment that are divided by, for example, lane and a length within each lane. This provides a granular assessment of risk within the segment as traffic and other conditions may vary between lanes along the segment and the risk of different safety events may also vary along the segment. In one approach, the system can package the lane-level risk information into a map and provide the map to approaching vehicles that the system identifies as within a defined range of the segment.

Communicating the map to the approaching vehicle, causes the approaching vehicle to assess the lane-level risk throughout the segment from which the vehicle can then take actions to mitigate the risk. For example, the vehicle can adapt the operation of one or more advanced driving assistance systems (ADAS) by altering operating parameters (e.g., speed, lane change, etc.), providing warnings to the driver, and so on. In this way, the system is able to improve the operation of the vehicle by better accounting for latent risks embodied in the map.

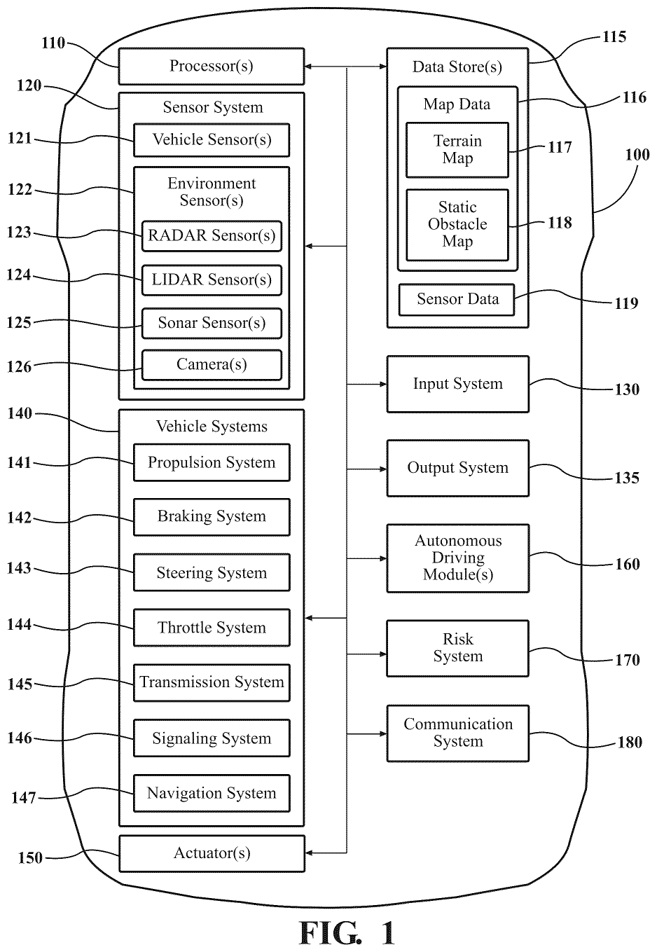

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any device that, for example, transports passengers. In various approaches, the vehicle 100 may be an automated vehicle. The vehicle 100 may operate autonomously, semi-autonomously, or with the assistance of various advanced driving assistance systems (ADAS). Further, the vehicle 100 is generally a connected vehicle that is capable of communicating wirelessly with other devices, such as other connected vehicles, infrastructure elements (e.g., roadside units), cloud-computing elements, and so on. Moreover, while the present disclosure is generally described in relation to the vehicle 100, in yet further approaches, the noted systems and methods disclosed herein may be implemented as part of other entities, such as electronic devices that are not associated with a particular form of transport but are instead embedded as part of a mobile electronic device that can be, for example, carried by an individual and that may function independently or in concert with additional systems of other devices.

In any case, the vehicle 100 also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within the vehicle 100, while further components of the system are implemented within a cloud-based environment, as discussed further subsequently.

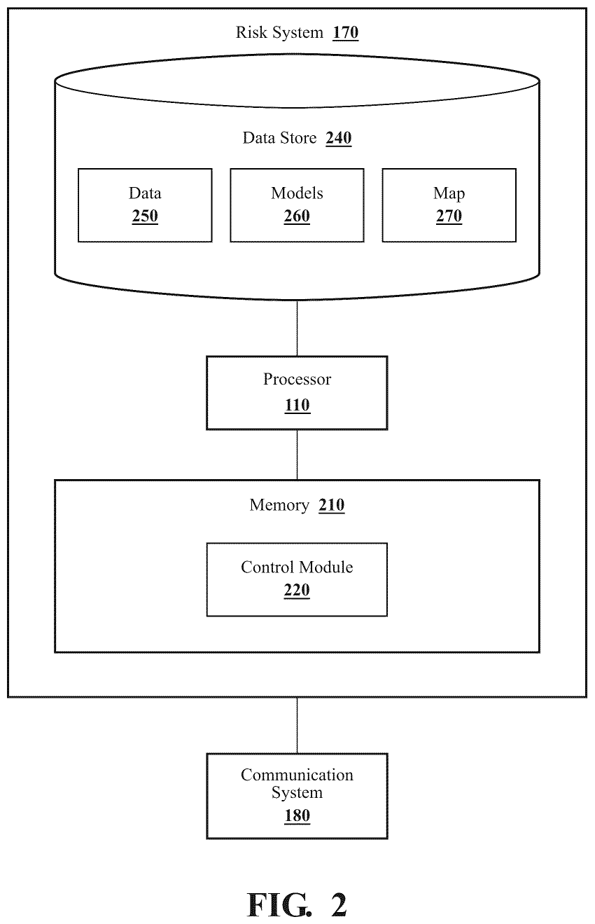

Some of the possible elements of the vehicle 100 are shown in FIG. 1 and will be described along with subsequent figures. However, a description of many of the elements in FIG. 1 will be provided after the discussion of FIGS. 2-7 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a risk system 170 that is implemented to perform methods and other functions as disclosed herein relating to determining lane-level risks and adapting operation of a vehicle according thereto.

Moreover, the risk system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the risk system 170 can leverage various wireless communication technologies to provide communications to other entities, such as members of the cloud-computing environment.

With reference to FIG. 2, one embodiment of the risk system 170 is further illustrated. The risk system 170 is shown as including a processor 110 from the vehicle 100 of FIG. 1. Accordingly, the processor 110 may be a part of the risk system 170, the risk system 170 may include a separate processor from the processor 110 of the vehicle 100 or the risk system 170 may access the processor 110 through a data bus or another communication path. In further aspects, the processor 110 is a cloud-based resource. Thus, the processor 110 may communicate with the risk system 170 through a communication network or may be co-located with the risk system 170. In one embodiment, the risk system 170 includes a memory 210 that stores a control module 220. The memory 210 is a random-access memory (RAM), read-only memory (ROM), a hard-disk drive, a flash memory, or other suitable memory (either volatile or non-volatile) for storing the module 220 and/or other information used by the risk system 170. The module 220 is, for example, computer-readable instructions within the physical memory 210 that, when executed by the processor 110, cause the processor 110 to perform the various functions disclosed herein.

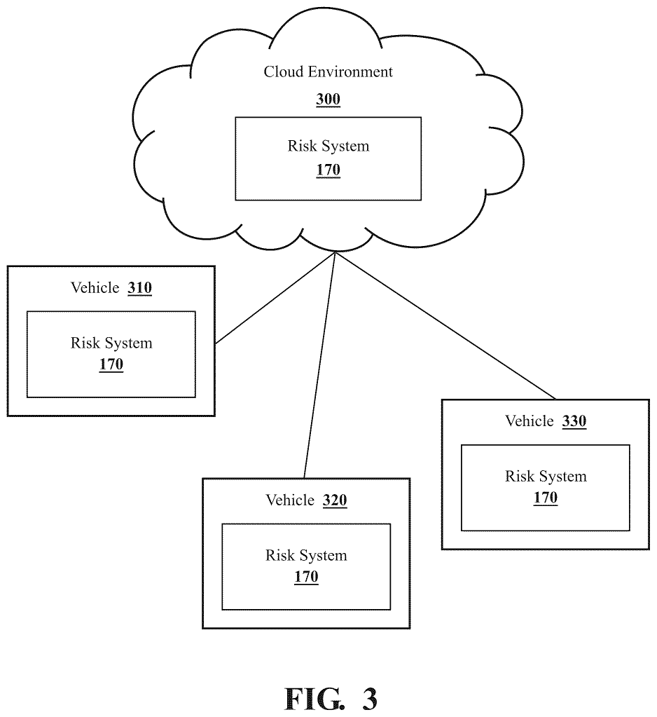

As previously noted, the risk system 170 may be further implemented within the vehicle 100 as part of a cloud-based system that functions within a cloud environment 300, as illustrated in relation to FIG. 3. That is, for example, the risk system 170 may acquire data (e.g., telematics data, sensor data, etc.) from various entities, such as distributed vehicles implementing separate instances of the risk system 170. In one or more approaches, the cloud environment 300 may facilitate communications between multiple different entities, including one or more of vehicles 310, 320, and 330 and a cloud-based server within the cloud environment 300.

Accordingly, as shown, the risk system 170 may include separate instances within one or more entities of the cloud-based environment 300, such as servers, and also instances within vehicles that function cooperatively to acquire, analyze, and distribute the noted information. In a further aspect, the entities that implement the risk system 170 within the cloud-based environment 300 may vary beyond transportation-related devices and encompass mobile devices (e.g., smartphones), and other such devices that may be carried by an individual within a vehicle, and thereby can function in cooperation with the vehicle. Thus, the set of entities that function in coordination with the cloud environment 300 may be varied.

The cloud-based environment 300 itself, as previously noted, is a dynamic environment that comprises cloud members that are routinely migrating into and out of a geographic area. In general, the geographic area, as discussed herein, is associated with a broad area that may include dividing roads into separate segments. As will be discussed in greater detail subsequently, the risk system 170, in at least one arrangement, acquires data from vehicles about different road segments and also provides lane-level risk information to vehicles as the vehicles approach the road segments. In any case, the area associated with the cloud environment 300 can vary according to a particular implementation but generally extends across a wide geographic area.

Continuing with FIG. 2 and a general embodiment of the risk system 170, in one or more arrangements, the risk system 170 includes a data store 240. The data store 240 is, in one embodiment, an electronic data structure (e.g., a database) stored in the memory 210 or another electronic memory and that is configured with routines that can be executed by the processor 110 for analyzing stored data, providing stored data, organizing stored data, and so on. Thus, in one embodiment, the data store 240 stores data used by the module 220 in executing various functions. In one embodiment, the data store 240 includes the data 250, models 260, a map 270, and/or other information that is used by the module 220. It should be appreciated that while the data store 240 is shown as including the data 250, the models 260, and the map 270, separate instances of the risk system 170 may implement the data store 240 to include different sets of information.

In any case, the control module 220 includes instructions that function to control the processor 110 to acquire the data 250 about a surrounding environment of the vehicle 100. It should be appreciated that the control module 220 acquires the data 250 when serving in various different capacities within an area. That is, the vehicle 100 may itself be simply navigating through the area of a specific road segment or may be approaching the specific road segment. Depending on the location of the vehicle 100 with respect to a road segment that the risk system 170 is assessing/monitoring, the role of the vehicle 100 may vary between information gatherer and risk mitigator. In any case, the risk system 170 captures observations of the surrounding environment in the form of the data 250 that the risk system 170 can process into observations and/or simply provide to a cloud-based instance of the risk system 170.

Accordingly, the control module 220 generally includes instructions that cause the processor 110 to control one or more sensors of the vehicle 100 to generate an observation about the surrounding environment. Broadly, an observation, as acquired by the control module 220, is information about a particular driving environment (e.g., roadway) and objects present in the driving environment as perceived by at least one sensor. Thus, the observation is generally a group of one or more data that can be processed into a derived determination about the environment (e.g., traffic speed, location of vehicles, traffic density, weather conditions, etc.).

The control module 220, in one embodiment, controls respective sensors of the vehicle 100 to provide the data inputs in the form of the data 250. The control module 220 may further process the data 250 into separate observations of the surrounding environment. For example, the control module 220, in one approach, fuses data from separate sensors to provide an observation about a particular aspect of the surrounding environment. By way of example, the sensor data 250 itself, in one or more approaches, may take the form of separate images, radar returns, LiDAR returns, and so on. The control module 220 may derive determinations (e.g., location, pose, characteristics, etc.) from the data 250 and fuse the data for separately identified aspects of the surrounding environment, such as surrounding vehicles, pedestrians, and so on. The control module 220 may further extrapolate the data 250 into an observation by, for example, correlating the separate instances of the data 250 into a meaningful observation about an object beyond an instantaneous data point. For example, the control module 220 may track a pedestrian over many data points to provide an indication of a trajectory.

Additionally, while the control module 220 is discussed as controlling the various sensors to provide the sensor data 250, in one or more embodiments, the module 220 can employ other techniques that are either active or passive to acquire the sensor data 250. For example, the control module 220 may passively sniff the data 250 from a stream of electronic information provided by the various sensors or other modules/systems in the vehicle 100 to further components within the vehicle 100. Moreover, the data 250 may include information about the vehicle 100 itself, such as a location, a speed, and so on. Thus, the data 250, in one embodiment, represents a combination of perceptions acquired from multiple sensors.

Of course, depending on the sensors that the vehicle 100 or another entity includes, the available data 250 that the risk system 170 can harvest may vary. As one example, according to a particular implementation, the vehicle 100 may include different types of cameras or placements of multiple cameras. When acquiring the data 250, the control module 220 may acquire various electronic inputs that originate from the vehicle 100, which may be stored in the data store 240 of the risk system 170 as the data 250 and processed according to various algorithms, such as machine learning algorithms, heuristics, and so on. Accordingly, the risk system 170, in one approach, uses the noted data 250 along with perceptions derived from the data 250 to assess risks along road segments.

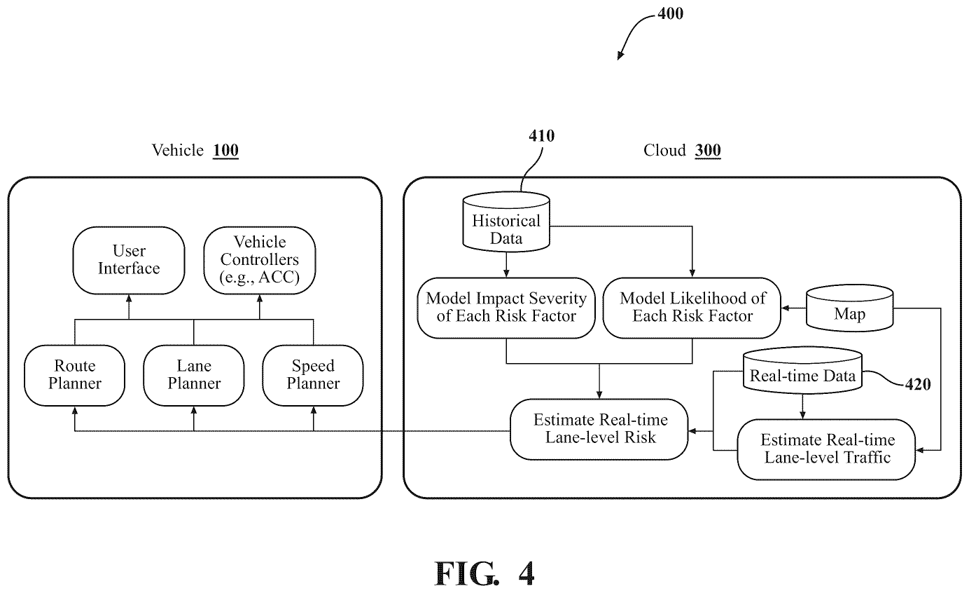

Continuing with discussion of elements represented in FIG. 2, in various implementations, the control module 220 includes instructions to train the models 260 using the data 250, which has been accumulated from, for example, many observations of different vehicles. With additional reference to FIG. 4, which illustrates a system diagram 400 of one implementation of the risk system 170, consider historical data 410. The historical data 410 illustrated in FIG. 4 is, for example, data within a database that includes data collected from multiple different road segments. In general, the data is about different safety events that relate to accidents involving vehicles on the road segments. As such, the historical data 410 can include crash reports, and/or direct observations of information (e.g., traffic, weather, roadway conditions, etc.) about the segment. The safety events may be associated with occurrences of cut-ins, cut-outs, slow vehicles, emergency vehicles, bicyclists, pedestrians/workers, animal crossings, aggressive drivers, and so on. In further arrangements, the safety events are further associated with semi-static aspects of an environment, including potholes and other conditions of the road surface, ice/snow, loose gravel, debris, obscured/missing signs, construction zones, obscured views, and so on. In yet further aspects, the safety events may also be associated with static aspects of the environment, including narrow shoulders, soft shoulders, narrow bridges, and so on.

In any case, the historical data 410 characterizes the occurrence of the safety events at different segments and represents aggregated information from multiple vehicles and different days and times. As such, the risk system 170 can use the historical data 410 as a way to characterize different aspects of the safety events through the training of the models 260. The models 260 are, for example, machine learning models, such as statistical models (e.g., a negative binomial model). The risk system 170 uses the historical data 410 to train the models 260, which are specific to a particular safety event. That is, the risk system 170 trains a different set of the models 260 for each different safety event. The models 260 can include a likelihood model and an impact model for respective separate safety events. The likelihood model characterizes the likelihood of the occurrence of a specific safety event according to current conditions of the road segment. The impact model characterizes a severity of the occurrence of the safety event when the safety event occurs. That is, the impact model generally identifies a severity of the threat associated with the safety event relating to how hazardous or dangerous the occurrence is to a vehicle involved in the safety event.

With further reference to FIG. 4, the system 400 further includes real-time data 420, which is a current occurrence of the data 250 as presently observed for a road segment. As shown, the control module 220 can use the data 420, in at least one approach, to derive observations about the traffic for a segment, which is then packaged into a map. The impact model and the likelihood model can then generate an impact and a likelihood that are combined into a lane-level risk for the segment. The risk system 170 can represent the lane-level risk for the segment in a grid that includes cells. The cells are generally associated with distinct lanes and have a defined length (e.g., 100 m). Thus, each cell includes a specifically calculated lane-level risk so that a granular determination about the location of the lane-level risk for the safety event can be provided.

As further shown, the cloud 300 then provides the lane-level risk in the form of a map, including the cells to the vehicle 100. Here, the vehicle 100 is shown as receiving the map with the lane-level risk; however, it should be appreciated that the map is provided to any participating vehicle that is identified as approaching the segment. That is, the cloud 300 may track the vehicle 100 and determine when the vehicle 100 is within a defined distance (e.g., 1 km) of the segment. At this point, the risk system 170, as embodied as a cloud-side instance, communicates the map to the vehicle 100 to inform the vehicle of upcoming risks. The instance of the risk system 170 within the vehicle 100 can then use the map to adapt functioning of various systems within the vehicle 100 in order to mitigate the lane-level risk. For example, in one arrangement, the risk system 170 adjusts the operation of one or more advanced driving assistance systems (ADAS), such as a lane change assist (LCA), adaptive cruise control (ACC), and so on.

In further arrangements, the risk system 170 provides the map with the lane-level risk to other systems of the vehicle 100, such as a route planner, a lane planner, a speed planner, etc. In yet further arrangements, the risk system 170 may provide an alert or other message to a driver of the vehicle 100 about the risks. In regards to the ADAS or other vehicle systems, the systems can then use the lane-level risk to adjust speeds, change lanes, or perform other actions in order to avoid the risks. As such, the risk system 170 can use the models 260 to derive probabilities about the segment according to real-time data from which the system 170 can cause approaching vehicles to adapt their behavior.

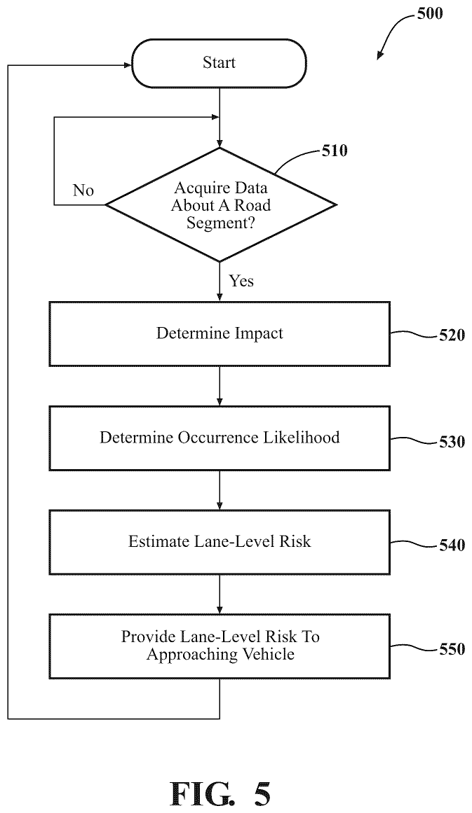

Additional aspects about determining lane-level risks will be described in relation to FIG. 5. FIG. 5 illustrates a flowchart of a method 500 that is associated with analyzing data to determine lane-level risks. Method 500 will be discussed from the perspective of the risk system 170 of FIGS. 1-2. While method 500 is discussed in combination with the risk system 170, it should be appreciated that the method 500 is not limited to being implemented within the risk system 170 but is instead one example of a system that may implement the method 500. Furthermore, while the method is illustrated as a generally serial process, various aspects of the method 500 can execute in parallel to perform the noted functions.

As an initial note, the methods 500 and 600 are generally described from the perspective of using real-time data to assess the lane-level risk of a particular road segment and providing the lane-level risks to vehicles so that the vehicles can improve navigating the road segments with awareness of the risks. It should be appreciated that the process of determining the risks and adapting operation of the vehicle generally occurs once the models 260 have been trained. Thus, the risk system 170, as discussed in relation to the methods 500 and 600, is presumed to have previously trained the models 260 using aggregated information about a road segment. Of course, the risk system 170 may still refine the training or even retrain the models 260 according to subsequently acquired data. However, the focus of the methods 500 and 600 is on the use of the models 260 for inference as opposed to training. Moreover, the method 500 is directed to a cloud-side instance of the risk system 170, whereas the method 600 is directed to a vehicle-side instance of the risk system 170.

At 510, the control module 220 monitors for data from a remote source (e.g., a connected vehicle, a roadside unit, etc.). As previously noted, the data 250 is about a surrounding environment of the entity that is collecting the data 250. It should be appreciated that acquiring the data 250, while shown as a single discrete instance, generally occurs as a series of observations over time and may be acquired by multiple different entities that separately communicate with the risk system 170 within the cloud environment 300. In this way, the control module 220 is able to capture changes within the environment to accurately assess the road segment. In any case, the data 250 is information from sensors of a connected vehicle or other connected entity that embodies an area of the road segment. For example, the data may be traffic density, traffic flow rates, information that provides for calculating the density/flow, and/or additional observations about conditions of the segment.

Regarding the segment of the roadway itself, the present discussion generally describes a single segment; however, it should be noted that the risk system 170 can access a multiplicity of segments in parallel to provide the lane-level risk, and a single segment is described only for purposes of brevity. Moreover, an individual road segment generally has a defined length (e.g., 0.25 miles), which may be defined according to a standard length or may vary according to a particular road feature, such as a merge, an on-ramp, an off-ramp, etc. That is, the length of a segment may be defined according to the defined length unless a particular feature justifies adapting the length in order to have a logical division of segments (e.g., avoiding splitting a road feature between multiple segments). Moreover, the risk system 170 can further divide the separate segments into discrete cells of a mesh/grid in order to provide the lane-level risk at a fine granularity in relation to different areas of the road segment. That is, the risk system 170 can divide a segment according to lanes and also separate lengths along the lanes in order to provide a further division of the segment. The risk system 170 can then provide the lane-level risk on a per-cell basis so that the vehicle can be aware of risks relative to lanes and areas along the lanes.

At 520, the control module 220 estimates an impact of a safety event for the segment. The impact characterizes a severity of an occurrence of the safety event. Accordingly, in various arrangements, the control module 220 may calculate an impact for each separate type of safety event for which the risk system 170 has a model for the segment. In further arrangements, the risk system 170 may instead determine the impact for safety events according to different conditions (e.g., safety events limited to nighttime or daytime, limited to adverse weather, such as freezing temperatures, and so on). As such, the risk system 170 is, in one or more configurations, able to selectively consider different safety events. In any case, the control module 220 uses the impact model for the safety event in combination with the real-time data to generate the determination of the impact.

At 530, the control module 220 estimates a likelihood of an occurrence of the safety event at the segment. In one approach, the control module 220 determines the likelihood using the likelihood model for the safety event in combination with the real-time data for the segment. The likelihood is generally a probability of the safety event according to the current conditions as embodied in the real-time data. Thus, the probability of the safety event occurring generally changes depending on, for example, the traffic density, the flow rate, and so on.

At 540, the control module 220 estimates the lane-level risk for the segment. In general, the control module 220 combines (e.g., multiplies) the impact with the likelihood to determine the lane-level risk. As noted previously, the segment may be divided into separate cells of a grid and the control module 220 may then determine the lane-level risk on a per-cell basis. As a further aspect, in addition to determining the lane-level risk for a single given safety event, the control module 220 may further aggregate the risks for multiple safety events together. That is, when the risk of multiple different safety events for a single segment exists, and the control module 220 determines the separate lane-level risks, the control module 220 can determine the combined risk for all safety events at each cell and provide the combined lane-level risks.

At 550, the control module 220 provides the lane-level risk to one or more approaching vehicles. In at least one arrangement, the control module 220 can monitor locations of different vehicles. Thus, the control module 220 may define a threshold distance from a segment or may define different regions that include multiple segments. In either case, the control module 220 determines when the vehicle is approaching the segment according to a current location of the vehicle in relation to the segment or whether the vehicle is approaching the region associated with the segment. When this occurs, the control module 220 communicates (e.g., via a wireless connection) the lane-level risk to the vehicle. The control module 220 may package the lane-level risk differently depending on the implementation. For example, the control module 220 may provide the lane-level risk in the form of a map that discretizes the segment into the grid cells with the separate risks. In a further arrangement, the lane-level risk may be simply provided as a table or using another data structure that includes the associated values and locations.

Whichever approach is undertaken, the risk system 170 causes an approaching vehicle to selectively adapt operation according to the lane-level risk. That is, various systems of the vehicle 100 may automatically consider the lane-level risks in relation to a current location of the vehicle 100 and adapt operating parameters of the systems according to the lane-level risk. For example, when the vehicle 100 is traveling in a lane with a significant risk that is within a define distance, then the risk system 170 may cause the vehicle system (e.g., ADAS) to adapt operation. This may include, for example, adjusting a speed, causing a lane change, etc. Of course, in further arrangements, the control module 220 may manifest the lane-level risk in different ways, such as alerts, etc.

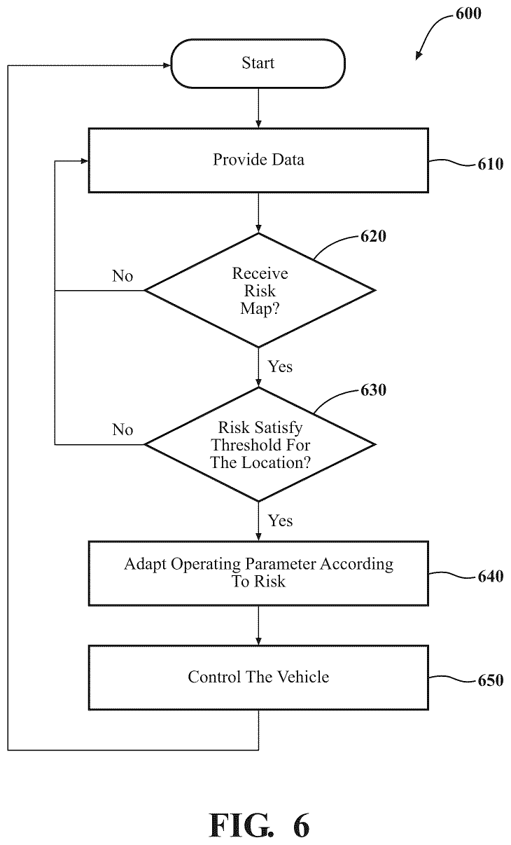

FIG. 6 illustrates a flowchart of a method 600 that is associated with functions of a vehicle (e.g., vehicle 100) that implements a remote instance of the risk system 170. Method 600 will be discussed from the perspective of the risk system 170 of FIG. 2. While method 600 is discussed in combination with the risk system 170, it should be appreciated that the method 600 is not limited to being implemented within the risk system 170 but is instead one example of a system that may implement the method 600. Furthermore, while the method is illustrated as a generally serial process, various aspects of the method 600 can execute in parallel to perform the noted functions.

At 610, the risk system 170 provides the data 250 from the vehicle 100 to the cloud. In at least one approach, the risk system 170 acquires sensor data from various sensors of the vehicle 100, which can include external sensors observing the surroundings of vehicle 100 (e.g., images, radar, etc.) and internal sensors observing aspects of the vehicle 100 itself (e.g., speed, location, etc.). Once acquired, the risk system 170 communicates the data 250 to the cloud-based instance.

At 620, the risk system 170 monitors for a communication from the cloud-based instance, including the lane-level risk. The communication may include a map embodying the lane-level risk or another data structure. In either case, acquiring the lane-level risk then induces further functions within the risk system 170, as described subsequently.

At 630, the risk system 170 determines whether the lane-level risk(s) indicated by the map satisfy a threshold for adapting the operation of the vehicle 100. That is, for example, the threshold may indicate a distance to the risk and a minimum risk for performing an associated function, such as adapting one or more operating parameters. Accordingly, the risk system 170 may determine when the location of the vehicle 100 and the lane-level risk satisfy the threshold (e.g., meets or exceeds) in order to then proceed with adapting the operating parameters. In various arrangements, the risk system 170 may consider aspects, such as a current path/lane of the vehicle 100, the current location, a type of the safety event, and a minimum risk for the type of the safety event.

At 640, the risk system 170 adapts one or more operating parameters according to the lane-level risk. In at least one approach, the risk system 170 adapts the operating parameters by an extent that is related to the lane-level risk. For example, in at least one aspect, a higher risk may correspond to a higher adaptation of an operating parameters. By way of example, the risk system 170 may alter an adaptive cruise control (ACC) speed to a greater extent for a more severe risk (e.g., reduce to 45 mph for a severe risk compared to 60 mph from a speed limit of 70 mph for a slight risk).

At 650, the risk system 170 causes the vehicle 100 to be controlled according to the adapted operating parameters. It should be appreciated that the control of the vehicle 100 may vary depending on the particular operating parameter and does not necessitate direct operational changes but may instead involve displaying messages/alerts, adapting inputs to various planning systems so that the planning systems can account for the risk, and so on. Accordingly, the risk system 170 may vary the way in which the operation of vehicle 100 is adapted depending on the implementation.

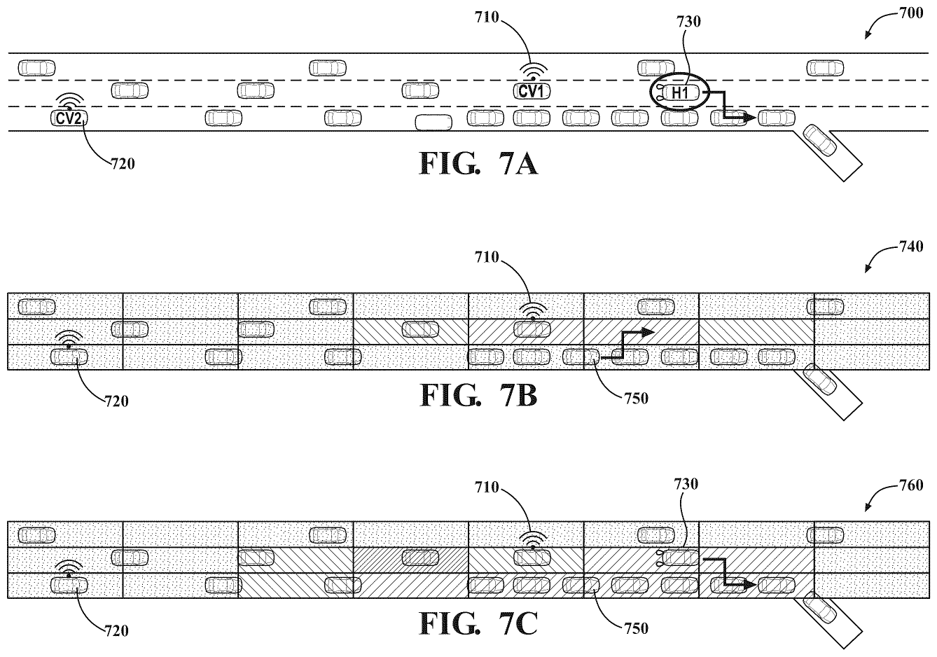

As a further explanation of the risk system 170, reference will now be made to FIGS. 7a-c. FIGS. 7a-c illustrate examples of different safety events or combinations of events. For example, FIG. 7a illustrates an example of a segment 700 where two connected vehicles 710 and 720 observe a cut-in maneuver by vehicle 730. The segment 700 shows a congested highway exit with stopped/slow vehicles on the through lanes. The vehicle 730 is attempting to perform a cut-in to the congested exit lane, which risks causing accidents, such as a rear-end collision. In the instant example, the vehicle 710 communicates the data 250 about a real-time current condition of the segment 700. In this example, the data 250 may include observations of the stopped/slow vehicles in the exit lane, a speed of the lane in which the vehicle 710 is traveling, a presence of the vehicle 730 that is attempting to cut-in, and other conditions (e.g., weather, length of the queue, time of day, etc.). Thus, the risk system 170 within the cloud collects this information from at least the vehicle 710 and determines the lane-level risk.

To estimate the lane-level risk, the risk system 170 estimates the distribution of not seeing a stopped vehicle (safety event) based on the existing conditions (i.e., the data 250). To achieve this, the risk system 170 can generate a mesh over the segment and estimate the likelihood according to the likelihood model, as shown in equation (1).

$${μ}_{i} = L \times exp ( β x ) \qquad ( 1 )$$

In equation (1), μᵢ is the likelihood of a given cell where x covariates, such as queue length, traffic density, through and exit flow rates, etc.

The risk system 170 further determines the impact according to the impact model. In particular, for each risk factor, the cloud models the potential impact (yᵢ) if a driver encounters the risk factor. For the cut-in scenario of FIG. 7a, the impact can depend on factors such as relative speed of the cut-in vehicle and its preceding vehicles, weather, road surface conditions, vehicle type, etc. If a vehicle stopped on the adjacent lane to cut-in, the impact can be significant if another vehicle is approaching at a high speed. In one approach, the impact can be categorized, such as high, low, etc. Alternatively, the impact can be defined according to a numeric scale (e.g., 1 to 10). In any case, the impact model is trained to determine the impact from the data 250.

The risk system 170 then estimates the lane-level risk by estimating the distribution parameters and the probability of observing no cut-in vehicle at the cell i (survival rate, Sᵢ), estimating the probability of observing at least one risk factor in a cell P(r)ᵢ=1-Sᵢ, and determining the lane-level risk according to equation (2).

$${R}_{i} = {P ( r )}_{i} \times {y}_{i} \qquad ( 2 )$$

The cloud-based instance of the risk system 170 can then send the lane-level risk to the upstream vehicle 720 to facilitate mitigating the risk, which may involve the LCA performing a lane change to the outside lane to avoid the cut-in vehicle 730.

FIG. 7b illustrates an example cut-out scenario 740 in which a vehicle 750 traveling in a congested lane on a highway attempts to exit the congested lane and merge into a faster-moving lane. This safety event can result in crashes as vehicles traveling at high speed on the less congested center lane may suddenly and unexpectedly face a slow-moving vehicle (i.e., vehicle 750). Similar to the example of FIG. 7a, the cloud-based instance collects data from at least the vehicle 710. This example shows how the specific cells may experience different risks than with the cut-in scenario since the vehicles are more likely to cut-out earlier in the queue while the cut-in is more likely to happen closer to the exit. Thus, as shown in FIG. 7b, the cells having a greater risk (i.e., the darker shaded cells in the center lane) are farther removed from the exit.

Turning to FIG. 7c, an example 760 with multiple risk factors is presented. In this example, the cloud-based instance of the risk system 170 computes a risk for each cell by considering risk factors associated with both cut-ins and cut-outs. For each risk factor, the system 170 collects data, and executes the separate likelihood and impact models for the associated safety event. The system 170 estimates the distribution of parameters and the probability of not observing a risk factor (n) (e.g., likelihood) at a cell I (survival rate, S_{i,n}). The system 170 further estimates the survival rate for all risk factors as:

$${S}_{i} = {S}_{i , 1} ⋂ {S}_{i , 2} ⋂ … ⋂ {S}_{i , n} = {\prod }_{1}^{n} {S}_{i , n} \qquad ( 3 )$$

The system 170 can then estimate the probability of observing at least one risk factor in a cell P(r)ᵢ=1−Sᵢ, thereby providing Rᵢ=P(r)ᵢ×yᵢ as the risk in each cell. FIG. 7c shows the combined risks for the separate grid cells of the segment with darker shaded cells corresponding to higher risks. As shown, the higher risks correspond, in general, with the areas of congestion and proximate areas where the associated safety events (e.g., cut-ins, cut-out, etc.) are most likely to occur. As such, the approaching vehicle 720 receives the lane-level risks in the associated map of FIG. 7c and can adapt operation to avoid the areas of risk or at least alter operation to slow down or present an alert to a driver to improve awareness. In this way, the risk system 170 is able to improve the safety of the vehicle 100 by considering areas of increased risks and providing information to approaching vehicles to mitigate the risks.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Of course, in further aspects, the vehicle 100 may be a manually driven vehicle that may or may not include one or more driving assistance systems, such as active cruise control, lane-keeping assistance, crash avoidance, and so on. In any case, “manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills, etc. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include various types of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the risk system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, and/or the automated driving module(s) 160 may control some or all of these vehicle systems 140 and, thus, may be partially or fully autonomous.

The processor(s) 110, and/or the automated driving module(s) 160 can be operatively connected to communicate with the various vehicle systems 140 and/or individual components thereof. For example, returning to FIG. 1, the processor(s) 110, the risk system 170, and/or the automated driving module(s) 160 can be in communication to send and/or receive information from the various vehicle systems 140 to control the movement, speed, maneuvering, heading, direction, etc. of the vehicle 100. The processor(s) 110, the risk system 170, and/or the automated driving module(s) 160 may control some or all of these vehicle systems 140.

The processor(s) 110, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the automated driving module(s) 160 can control the direction and/or speed of the vehicle 100. The processor(s) 110, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, obstacles, or other environmental features, including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the risk system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A risk system, comprising:
one or more processors; and
a memory communicably coupled to the one or more processors and storing:
a control module including instructions that, when executed by the one or more processors, cause the one or more processors to:
acquire data about a segment of a roadway, the data indicating at least information about traffic on the segment;
determine a lane-level risk associated with a safety event occurring on the segment using a likelihood model and an impact model; and
provide the lane-level risk to cause an approaching vehicle to selectively adapt operation.

2. The risk system of claim 1, wherein the control module includes the instructions to determine the lane-level risk associated with the segment including instructions to estimate a likelihood of an occurrence of the safety event at the segment, and
wherein the safety event is a hazard to traffic driving on the segment, including one or more of: a cut-in, a cut-out, hazardous road conditions, and static road conditions.

3. The risk system of claim 1, wherein the control module includes the instructions to determine the lane-level risk associated with the segment including instructions to estimate an impact of a safety event at the segment that characterizes a severity of an occurrence of the safety event.

4. The risk system of claim 1, wherein the control module includes the instructions to determine the lane-level risk including instructions to combine an impact of the safety event with a likelihood of the safety event occurring to estimate the lane-level risk according to discrete cells of the segment, and
wherein the likelihood model and the impact model are machine-learning models trained on historical data for the segment associated with the safety event.

5. The risk system of claim 1, wherein the control module includes the instructions to acquire the data about the segment including instructions to acquire the data from one or more vehicles traversing the segment in real-time, the data including at least traffic density, and traffic flow rates.

6. The risk system of claim 1, wherein the control module includes the instructions to provide the lane-level risk including instructions to identify that the approaching vehicle is nearing the segment and communicating a map that discretizes the segment into cells with the lane-level risk for respective ones of the cells.

7. The risk system of claim 1, wherein the control module includes the instructions to provide the lane-level risk that cause the approaching vehicle to adjust one or more operating parameters of an advanced driving assistance system (ADAS), and
wherein the ADAS includes at least one of adaptive cruise control (ACC) or lane change assist (LCA).

8. The risk system of claim 1, wherein the control module includes the instructions to determine the lane-level risk including instructions to aggregate risk factors for multiple different safety events into the lane-level risk.

9. A non-transitory computer-readable medium storing instructions that, when executed by one or more processors, cause the one or more processors to:
acquire data about a segment of a roadway, the data indicating at least information about traffic on the segment;
determine a lane-level risk associated with a safety event occurring on the segment using a likelihood model and an impact model; and
provide the lane-level risk to cause an approaching vehicle to selectively adapt operation.

10. The non-transitory computer-readable medium of claim 9, wherein the instructions to determine the lane-level risk associated with the segment include instructions to estimate a likelihood of an occurrence of the safety event at the segment, and
wherein the safety event is a hazard to traffic driving on the segment, including one or more of: a cut-in, a cut-out, hazardous road conditions, and static road conditions.

11. The non-transitory computer-readable medium of claim 9, wherein the instructions to determine the lane-level risk associated with the segment include instructions to estimate an impact of a safety event at the segment that characterizes a severity of an occurrence of the safety event.

12. The non-transitory computer-readable medium of claim 9, wherein the instructions to determine the lane-level risk include instructions to combine an impact of the safety event with a likelihood of the safety event occurring to estimate the lane-level risk according to discrete cells of the segment, and
wherein the likelihood model and the impact model are machine-learning models trained on historical data for the segment associated with the safety event.

13. The non-transitory computer-readable medium of claim 9, wherein the instructions to acquire the data about the segment include instructions to acquire the data from one or more vehicles traversing the segment in real-time, the data including at least traffic density, and traffic flow rates.

14. A method, comprising:
acquiring data about a segment of a roadway, the data indicating at least information about traffic on the segment;
determining a lane-level risk associated with a safety event occurring on the segment using a likelihood model and an impact model; and
providing the lane-level risk to cause an approaching vehicle to selectively adapt operation.

15. The method of claim 14, wherein determining the lane-level risk associated with the segment includes estimating a likelihood of an occurrence of the safety event at the segment, and
wherein the safety event is a hazard to traffic driving on the segment, including one or more of: a cut-in, a cut-out, hazardous road conditions, and static road conditions.

16. The method of claim 14, wherein determining the lane-level risk associated with the segment includes estimating an impact of a safety event at the segment that characterizes a severity of an occurrence of the safety event.

17. The method of claim 14, wherein determining the lane-level risk includes combining an impact of the safety event with a likelihood of the safety event occurring to estimate the lane-level risk according to discrete cells of the segment, and
wherein the likelihood model and the impact model are machine-learning models trained on historical data for the segment associated with the safety event.

18. The method of claim 14, wherein acquiring the data about the segment includes acquiring the data from one or more vehicles traversing the segment in real-time, the data including at least traffic density, and traffic flow rates.

19. The method of claim 14, wherein providing the lane-level risk includes identifying that the approaching vehicle is nearing the segment and communicating a map that discretizes the segment into cells with the lane-level risk for respective ones of the cells.

20. The method of claim 14, wherein providing the lane-level risk causes the approaching vehicle to adjust one or more operating parameters of an advanced driving assistance system (ADAS), and
wherein the ADAS includes at least one of adaptive cruise control (ACC) or lane change assist (LCA).
